(19) United States
(12) Patent Application Publication
(10) Pub. No.: US 2026/0228237 A1
(43) Pub. Date: Aug. 6, 2026

(54) DATABASE SYNCHRONIZATION WITH RATELESS INVERTIBLE BLOOM LOOKUP TABLES

(71) Applicant: Matillion Limited, Salford (GB)

(72) Inventors: John Adams, Coventry (GB); Robert John Appleyard, Stockport (GB); Shane Paul Darren Booth, Manchester (GB)

(21) Appl. No.: 19/042,078

(22) Filed: Jan. 31, 2025

(51) Int. Cl. G06F 16/27; G06F 16/22

(52) U.S. Cl. CPC G06F 16/275; G06F 16/2255

(57) ABSTRACT

A synchronization service synchronizes a source dataset on a source database and target dataset on a target database using the Rateless Invertible Bloom Lookup Table (IBLT) algorithm. The synchronization service iteratively requests coded symbols from the source database and target database generated at these databases according to the Rateless IBLT algorithm implemented using a relational database management system. The synchronization service attempts to decode the coded symbols at each iteration. When decoding succeeds, the synchronization service communicates differences between the source dataset and the target dataset indicated in the decoded symbols to the source database and/or the target database for dataset reconciliation.

### BACKGROUND

The disclosure generally relates to digital data processing and information retrieval (e.g., CPC subclass G06F/00) and techniques for file synchronization in file systems (e.g., CPC subclass G06F 16/178).

Bloom filters are probabilistic data structures that efficiently store hashes of elements of a set for determining whether a new element is a member of the set. Bloom filters map each set element to a fixed number of hash values for hashes of that element, wherein each hash value indicates an entry in an array. Adding an element to a bloom filter comprises hashing the element to determine the entries in the array that the element maps to and setting those values in the array to 1 if not already 1, with the array initialized as all zeroes. Determining whether a new element is a member of the set comprises hashing the new element to determine the entries of the array to which that element maps. If any of those entries are zero, the element is not in the set. If all of those entries are 1, then it is likely that element is in the set, but false positives are possible. The hash functions chosen for bloom filters have probabilistic properties that reduce the occurrence of false positives. The use of probabilistic hash functions in bloom filters is an extensible technique to other types of data structures such as Invertible Bloom Lookup Tables.

Set reconciliation is the task of reconciling two sets of data, i.e., ensuring that the two sets of data are the same. Reconciling two datasets often involves determining the symmetric difference of the datasets, i.e., determining which elements are in a set A but not a set B and which elements are in a set B but not a set A. Bloom filters, Invertible Bloom Lookup Tables (IBLTs) and other related techniques can be used for set reconciliation.

### BRIEF DESCRIPTION OF THE DRAWINGS

Embodiments of the disclosure may be better understood by referencing the accompanying drawings.

FIG. 1 is a protocol diagram of a synchronization service synchronizing a target dataset at a target database with a source dataset at a source database using sets of coded symbols generated via Rateless IBLTs.

FIG. 2 is a protocol diagram of a synchronization service synchronizing a source dataset at a source database and a target dataset at a target database using sets of coded symbols generated via Rateless IBLTs and an initial snapshot of the source dataset.

FIG. 3 is an illustrative diagram of examples for generating coded symbols and subtracting coded symbols.

FIG. 4 is a flowchart of example operations for synchronizing a target database with a source database using Rateless IBLTs.

FIG. 5 is a flowchart of example operations for synchronizing a target database with a source database using Rateless IBLTs and snapshots.

FIG. 6 is a flowchart of example operations for decoding differences between source coded symbols from a source database and target coded symbols from a target database.

FIG. 7 depicts an example computer system with a source database, a target database, a Rateless IBLT-based synchronization service, and a synchronization database.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Synchronizing datasets across databases that are disparately located incurs the bandwidth of communicating those datasets or representations of those datasets across the Internet to determine whether they are the same or different (i.e., set reconciliation). Invertible Bloom Lookup Tables (IBLTs) are a data structure that, while reducing bandwidth of data communicated for synchronization using compressed representations of datasets, does not have an a priori data structure size for set reconciliation. Moreover, if an IBLT data structure size is chosen incorrectly (i.e., too small for set reconciliation), an entirely new data structure has to be generated from scratch. As a result, there can be trial and error when two databases communicate IBLTs for respective datasets to a synchronization service. When there is a failure due to insufficient IBLT size, each database has to generate an additional IBLT at an increased size and communicate the additional IBLT to the synchronization service to determine whether the size is sufficiently large. Moreover, because IBLTs are a probabilistic data structure, there is no deterministic way to determine an IBLT size that will always be sufficiently large.

A synchronization service disclosed herein is configured in tandem with remotely disparate datasets for set reconciliation using Rateless IBLTs. Rateless IBLTs implement an improved IBLT data structure. The data structure comprises coded symbols generated from datasets and allows for communication of sets of coded symbols ad infinitum without the need to re-generate previously generated coded symbols when the current set of coded symbols is not sufficiently large. The synchronization service acts as an intermediary between a source database and a target database to synchronize a target dataset stored on the target database to be a replica of a source dataset on the source database.

Based detecting or receiving on a synchronization event, the synchronization service requests a first set of coded symbols of the source dataset from the source database and a second set of coded symbols of the target dataset from the target database. The source and target datasets generate the first and second sets of coded symbols using a relational database management system (RDBMS) implementation of the coded symbol generation sub-routine of the Rateless IBLT algorithm. The synchronization service then receives the first and second sets of coded symbols from the source and target datasets, respectively, and applies the decoding sub-routine of the Rateless IBLT algorithm to determine whether the first and second sets of coded symbols are sufficient for set reconciliation (i.e., sufficient for decoding differences between the source dataset and the target dataset). If there are sufficient coded symbols, the synchronization service decodes differences between the source and target datasets and pushes any updates to the source and target databases accordingly. Otherwise, the synchronization service requests additional sets of coded symbols from the source and target databases until there are sufficient coded symbols for decoding/set reconciliation.

The use of Rateless IBLTs for dataset synchronization across remote databases reduces bandwidth from having to communicate entire datasets from source and target databases and leverages efficient representations of database updates since last synchronization for more efficient database synchronization. The communication bandwidth and data structure size (i.e., number of generated coded symbols) for database synchronization using Rateless IBLTs is proportional to the size of differences in datasets to be synchronized, rather than being proportional to the size of the datasets themselves for previous approaches to database synchronization. The Rateless IBLT data structure is extensible because more coded symbols can be generated for future synchronization events without having to regenerate previously generated symbols. Moreover, the amount of generated coded symbols can be optimized across future database synchronization events based on expected dataset difference sizes for those synchronization events, and a large initial set of coded symbols can be generated and stored with minimal practical downside, allowing for subsequent decoding of large quantities of dataset differences.

### Example Illustrations

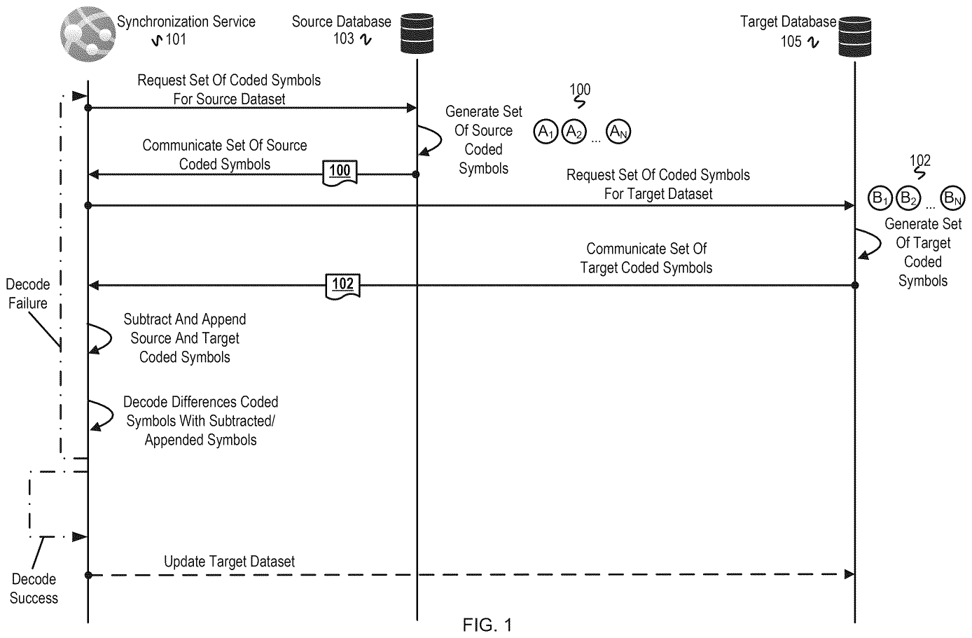

FIG. 1 is a protocol diagram of a synchronization service synchronizing a target dataset at a target database with a source dataset at a source database using sets of coded symbols generated via Rateless IBLTs. A synchronization service 101 synchronizes the source and target datasets using sets of coded symbols that are generated at the source database 103 and the target database 105 and decoded at the synchronization service 101 according to the Rateless IBLT algorithm. The sub-routine of the Rateless IBLT algorithm for generating sets of coded symbols that can be appended ad infinitum is implemented at the source database 103 and the target database 105 using an RDBMS (e.g., an object-RDBMS such as PostgreSQL). Moreover, operations for requesting coded symbols from databases and indicating parameters therein related to the requests can also be implemented using an RDBMS or other extensible database framework. FIG. 1 depicts the target database 105 as being updated to be a replica of the source database 103.

Based on detecting a synchronization event, the synchronization service 101 communicates a request for a set of coded symbols to the source database 103. The request indicates synchronization, for instance with a parameter value indicating synchronization (in contrast to requesting/querying data from the source database 103), and can additionally indicate a dataset, set of records (e.g., as referred by primary key values), etc. from the source database 103 that will be replicated at the target database 105. The source database 103 comprises a database that is frequently updated and/or has a backup at the target database 105 due to storing high priority data. For instance, the source database 103 can comprise a production database that is frequently updated with end user data/statistics, application data, etc.

Based on receiving the request for the set of coded symbols from the synchronization service 101, the source database 103 generates a set of source coded symbols 100 A₁, A₂, . . . , A_{N} of the source dataset indicated by the request. The number of coded symbols N is a fixed value (e.g., N=100) that is engineered by a domain-level expert to not be too large to overshoot the necessary number of coded symbols for typical dataset sizes but also not be too small to require repeatedly requesting the source database 103 and the target database 105 for coded symbols. The size of the set of source coded symbols 100 (i.e., N) is engineered based on the expected size of the differences between the source and target datasets during synchronization, and not the size of the entire source and target datasets as with previous approaches to database synchronization. This size can be optimized in future synchronizations based on expected numbers of differences across datasets observed from past synchronizations. Moreover, the use of Rateless IBLTs allows for generation of additional coded symbols without having to regenerate previously generated coded symbols for a synchronization event.

When generating the set of source coded symbols 100, the source database 103 first generates a representation of the source dataset. The choice of representations of the source dataset and the target dataset used in source symbols can be any representation of the source dataset and the target dataset agreed upon by the synchronization service 101, the source database 103, and the target database 105 prior to database synchronization. For instance, the representations can comprise entire rows of source data for synchronization of entire rows without further database interaction, primary key values of rows if primary key values that are inserted or deleted are able to be tracked, arbitrary length values (e.g., variable length characters) with corresponding hyperparameters indicating the length of the values, etc. The representations need only be deterministic and reversible across the synchronization service 101, the source database 103, and the target database 105.

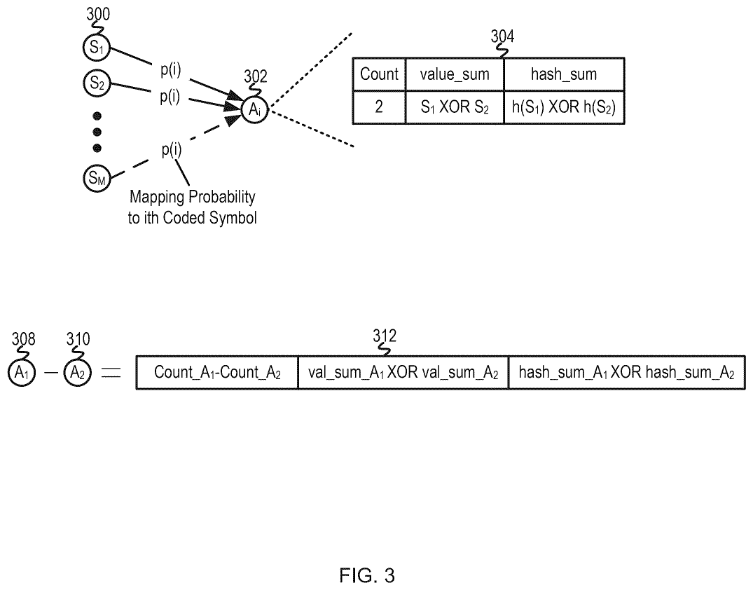

Once the representations of the source dataset are generated (or, alternatively, using the source dataset), the source database 103 randomly maps each source symbol (i.e., chunks of the records and/or representations of changes to the records in the source dataset) to each of the source coded symbols 100 according to a probability distribution engineered for Rateless IBLT. The probability distribution maps source symbols to source coded symbols with a probability according to the sequential order for which the source coded symbols are generating, starting with a first coded symbol. In the process of sequentially generating source symbols, the probability distribution maps every source symbol to the first coded symbol and maps source symbols to higher indexed coded symbols with successively decreasing probabilities. The source database 103 then applies hash functions, bitwise XOR operations, and count operations to each mapped set of source symbols for a coded symbol to generate the set of source coded symbols 100. The count operation tracks how many source symbols are encoded by a coded symbol. The source symbols comprise fixed length sections (e.g., 8-bit sections) of the records and/or representations of records (without the parameter values indicating the type of change operation). Mappings between source and coded symbols determining according to the probability distribution and the hash functions are agreed upon and implemented identically across the synchronization service 101, the source database 103, and the target database 105 so that the “randomness” (i.e., source-to-coded symbol mappings and hash functions) is the same when generating respective sets of coded symbols. For instance, a same implementation of a hash function with same hyperparameters can be deployed at the synchronization service 101, the source database 103, and the target database 105 so that hashes of same values will be computed identically. Operations for generating coded symbols from source symbols according to the Rateless IBLT algorithm are described in greater detail in reference to FIG. 3. Once generated, the source database 103 communicates the set of source coded symbols 100 to the synchronization service 101.

The synchronization service 101 also communicates a request to the target database 105 to generate a set of target coded symbols 102 B₁, B₂, . . . , B_{N}. The target database 105 generates the same number of coded symbols as the source database 103 (e.g., N=100). The source symbols used to generate the set of target coded symbols 102 comprise source symbols for records of the target dataset. As stated above, the hash functions and probability mappings are chosen to be the same for the sets of coded symbols 100, 102 so that the same source symbols are mapped to the same coded symbols and the same hash functions are applied to respective source symbols when generating the coded symbols. The target database 105 communicates the set of target coded symbols 102 to the synchronization service 101.

Based on receiving the sets of coded symbols 100, 102, the synchronization service 101 performs a subtraction operation on the sets of coded symbols 100, 102 and appends the subtracted set of coded symbols to existing subtracted/decoded coded symbols from previous iterations (i.e., when a previous decoding step failed). For the first iteration, there is nothing to append to, so the appended set of coded symbols comprises the sets of coded symbols 100, 102 with the subtraction operation applied.

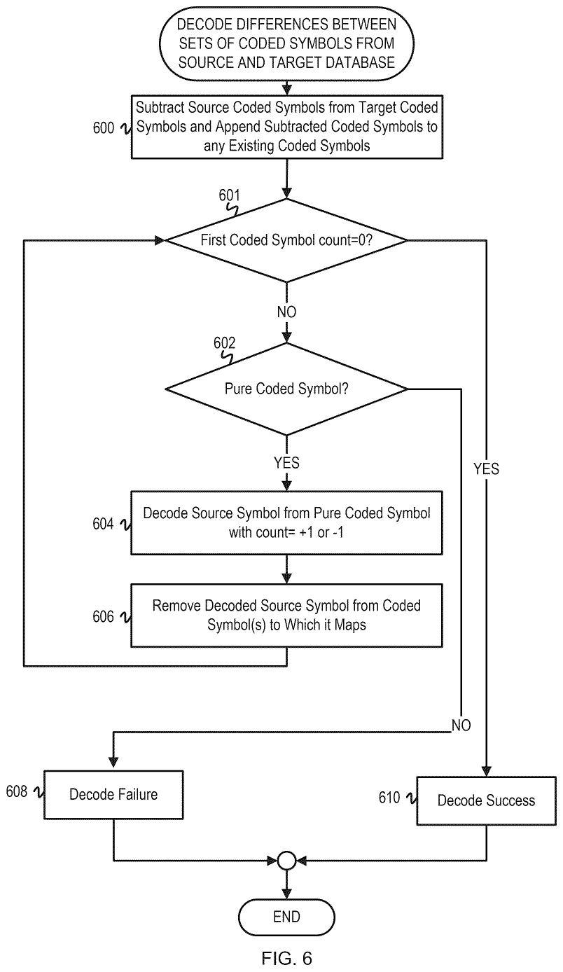

The synchronization service 101 then decodes differences between the source and target coded symbols using the subtracted/appended symbols resulting from the subtraction and appending operations. Decoding differences is performed as a “peeling” operation. Peeling involves identifying “pure” coded symbols having a count of 1 or −1 and that have a value in a hash field equal to the hash of a value stored in a value field of the coded symbol. These criteria mean that there is exactly one corresponding source symbol from either the source or target dataset encoded in the pure coded symbol. The synchronization service 101 decodes the corresponding source symbol from the coded symbol and removing the source symbol from all coded symbols to which the source symbol was mapped. This process continues as long as there remain coded symbols having a count of 1 or −1 and a stored hash value equal to a hash of the stored value. After decoding the differences, if the first coded symbol has a count that is not 0 and/or a non-zero hash value after decoding (i.e., all source symbols were not removed from the coded symbol), decoding has failed and the synchronization service 101 requests additional coded symbols from the source database 103 and the target database 105. Otherwise, if the first coded symbol has a count of 0, decoding was successful, and the synchronization service 101 communicates updates of the target dataset to the target database 105 based on the decoded differences. Operations for decoding between sets of coded symbols are described in greater detail in reference to FIG. 6.

Although the sets coded symbols 100, 102 are indexed by 1 to N, additional coded symbols requested from the source database 103 and target database 105 will be indexed by N+1 to 2N (and so on for additional coded symbols thereafter), and the mapping of source symbols to these coded symbols will be determined using the aforementioned probability distribution on these indices rather than the original 1 to N indices. Thus, mappings for additional iterations will have lower mapping probabilities than for previous iterations.

The updates to the target dataset communicated by the synchronization service 101 comprise records, indications of deletes for any records that are to be deleted, and indications of inserts or any records that are to be added. Updates of records (i.e., changes of row values with a record) can be represented as combinations of deletes and inserts when communicated as updates to the target database 105. When, during the generating of the set of source coded symbols 100, inserted records are represented as primary key values without corresponding rows, the synchronization service requests the full records corresponding to the primary key values from the source database 103 and communicates these full records for the inserts in the updates to the target dataset.

The source database 103 and the target database 105 can be part of an extract, transform, load (ETL) pipeline wherein data is extracted from the source database 103, transformed to a format of the target database 105, and loaded onto the target database 105. Prior to the synchronization operations depicted in FIG. 1, the source dataset on the source database 103 can be extracted and transformed for loading to the target database 105. Subsequently, differences between the extracted/transformed source dataset and the target dataset can be determined when performing set reconciliation and dataset synchronization.

The synchronization service 101 can be presented as a service (e.g., a software-as-a-service application) at an endpoint device managing at least the source database 103 and the target database 105. The endpoint device can configure synchronization between the source database 103 and the target database 105, for instance by synchronizing according to a schedule (e.g., every hour, day, week) and can manually instantiate synchronization as well.

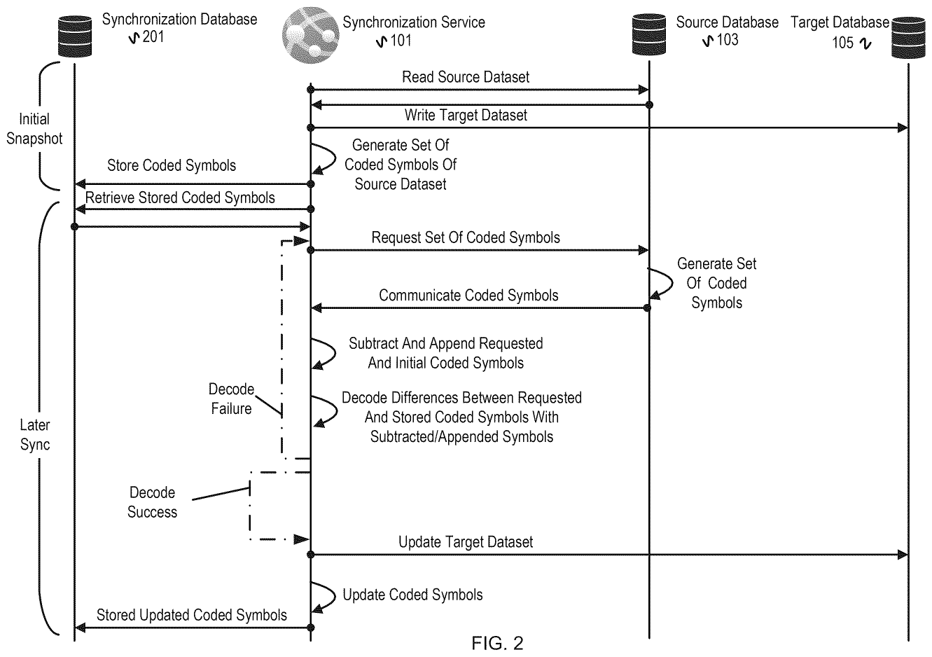

FIG. 2 is a protocol diagram of a synchronization service synchronizing a source dataset at a source database and a target dataset at a target database using sets of coded symbols generated via Rateless IBLTs and an initial snapshot of the source dataset. FIG. 2 depicts the synchronization service 101, the source database 103, and the target database 105 depicted in FIG. 1 as well as a synchronization database 201 for storing snapshots of datasets on the source database 103. The snapshots comprise sets of coded symbols of a source dataset on the source database 103 so that, for synchronization subsequent to each snapshot, the synchronization service 101 can compare more recent coded symbols of the source dataset to the coded symbols in the snapshot to determine any changes and communicate those changes for updating the target database 105. This avoids generating coded symbols for the target dataset at the target database 105 at the cost of having to generate the snapshots.

For an initial snapshot, the synchronization service 101 reads the full source dataset from the source database 103 and writes the source dataset to the target dataset on the target database 105. The synchronization service 101 then generates a set of coded symbols of the source dataset (e.g., according to the operations described in reference to FIG. 1) and communicates the set of coded symbols of the source dataset to the synchronization database 201 for storage and subsequent synchronization operations.

After the initial snapshot, when the synchronization service 101 detects a synchronization event for the source dataset and the target dataset, the synchronization service 101 retrieves the initial set of coded symbols from the initial snapshot from the synchronization database 201. The synchronization service 101 then requests a set of coded symbols from the source database 103, subtracts and appends the requested and initial set of coded symbols, and decodes the differences between the subtracted/appended coded symbols. This process occurs until the decoding is successful at the synchronization service 101, or the synchronization service 101 requests additional coded symbols from the source database 103 for a decoding failure as described above in reference to FIG. 1.

Once decoding is successful, the synchronization service 101 communicates updates to the target dataset to the target database 105 according to decoded differences between the initial snapshot and the most recent source dataset. The synchronization service 101 updates the coded symbols for the source dataset using the coded symbols communicated from the source database 103 during decoding and stores the updated coded symbols in the synchronization database 201 as a more recent snapshot for subsequent synchronizations.

In some embodiments, the stored coded symbols in a snapshot may be insufficient for decoding and the later sync may result in a failure. In this case, a full additional snapshot of the source dataset may be necessary. In the initial snapshot, the synchronization service 101 can generate a large initial set of coded symbols to store in the synchronization database 201. This allows for many subsequent synchronizations without having to re-snapshot the source dataset, at the cost of minimal additional storage and updating of the synchronization database 201. The use of Rateless IBLTs for this purpose means that the size of the initial set of coded symbols is not dependent on the size of source and target dataset for synchronization, allowing for subsequent optimization of the number of coded symbols to generate for each synchronization based on the observe number of coded symbols uses for previous synchronizations.

FIG. 3 is an illustrative diagram of examples for generating coded symbols and subtracting coded symbols. A set of source symbols 300 S₁, S₂, . . . , S_{M} of a dataset are each mapped to an i^{th} coded symbol 302 Aᵢ with probability p(i) sampled independently for each source symbol. The probability distribution for mapping each of the set of source symbols 300 to a coded symbol is chosen so that

$$p ( i ) = \frac{1}{1 + α ( i - 1 )}$$

for some parameter α>0. The probability of each source symbol mapping to the first coded symbol (i=1) is 1, so every source symbol is mapped to the first coded symbol A₁, and each mapping probability for additional coded symbols is successively smaller. For coded symbols generated on a source database and a target database, the mappings of source symbols to coded symbols are the same, so the source and target coded symbols each encode the same-indexed source symbols. In the example depicted in FIG. 3, the source symbols S₁ and S₂ are mapped to coded symbol 302 as indicated by the solid lines, whereas the source symbol S_{M} is not mapped to the coded symbol 302 as indicated by the dashed line. This example assumes that S₁ and S₂ are the only source symbols mapped to the coded symbol 302. Other types of probability distributions for determining mappings between source and coded symbols are additionally anticipated based on implementation choices/practicalities.

A data structure 304 representing the coded symbol 302 comprises a count field, a value_sum field, and a hash_sum field. The count field represents the number of source symbols mapped to the coded symbol 302 (2 in this example), the value_sum is the bitwise XOR of all source symbols mapped to the coded symbol 304, i.e., S₁ XOR S₂, and the hash_sum is the bitwise XOR of hash values for all hashes of source symbols mapped to the coded symbol 304, i.e. h(S₁) XOR h(S₂). As an example, assuming the value_sum is 8 bits and the hash_sum is 4 bits, the coded symbol 302 is initialized as an empty coded symbol:

{count = 0, value_sum = 00000000, hash_sum = 0000}.
If S₁ is the binary value 00101100 that hashes to value 1011, the coded symbol 302 is
updated with S₁ as:
{count = 1, value_sum-00101100, hash_sum = 1011}.
If S₂ is the binary value 10111010 that hashes to value 1001, the coded symbol is updated
as
{count = 1+1, value_sum = 00101100 XOR 10111010, hash_sum = 1011 XOR 1001}
={ count = 2, value_sum = 10111010, hash_sum = 1001}

The subtraction operation used when decoding encoded symbols is depicted by subtracting a coded symbol 308 A₁ from a coded symbol 310 A₁ to obtain the difference 312 of the coded symbols 308, 310. The difference 312 of the coded symbols 308, 310 is also a coded symbol having a count field of Count_A₁-Count_A₂, a val_sum field of:

val sum A₁ XOR val_sum_A₂,
and a hash sum field of:
hash sum A₁ XOR hash sum A₂. The subtraction operation removes any mapped
source symbols that were mapped to both coded symbols A₁, A₂.

As an illustrative example, continuing the above example, suppose that A₁ is the coded symbol that S₁ and S₂ were mapped to:

{count = 2, value_sum = 10111010, hash_sum = 1001}, and assume that A₂ is the coded
symbol that only S₁ was mapped to:
{count = 1, value_sum=00101100, hash_sum = 1011}. Then, using the above formula,

the difference is:

$$A 1 - A 2 = \{ count = 1 , value\_sum = 10111010 , hash\_sum = 1010 \} .$$

Note that this is just the coded symbol for S₂ and S₂ was the source symbol that was mapped to A₁ but not A₂. If Aᵢ was the coded symbol of S₁ and A₂ was the coded of S₁ and S₂, then the difference A₁−A₂ is the same except the count is −1 instead of 1. Thus, a count of 1 indicates a corresponding source symbol mapped to the first coded symbol but not the second source symbol, and a count of −1 indicates a corresponding source symbol mapped to the second source symbol but not the first source symbol. This means that, during peeling operations for decoding coded symbols, if a coded symbol has a count of +1 or −1, then a corresponding source symbol included in one dataset but not the other can easily be obtained from the value_sum field with the sign of the count indicating which of the source and target datasets in which the source symbol was included. This is what enables set reconciliation—identification of source symbol in one dataset but not the other. If two coded symbols are identical, i.e., have the same mapped source symbols, then the difference is the empty (0) code symbols, indicating that the corresponding source symbols are identical in both datasets.

As example implementations, the hash functions can be the Fowler-Noll-Vo (FNV)-1a hash function, the SipHash hash function, the SHA-256 hash function, etc. Pseudorandom numbers for seeding the hash functions and/or mapping between source and coded symbols can be generated with the permuted congruential generator algorithm, the Lehmer random number generator, the linear congruential generator, etc.

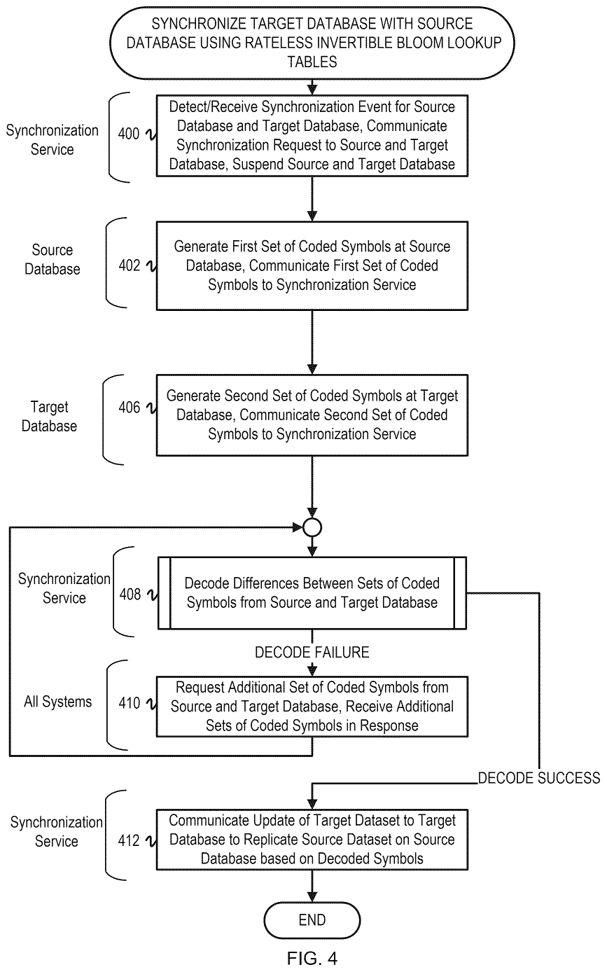

FIGS. 4-6 are flowcharts of example operations for synchronizing source and target databases using IBLTs. The example operations are described with reference to a source database, a target database, a synchronization service, and a synchronization database for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 4 is a flowchart of example operations for synchronizing a target database with a source database using Rateless IBLTs. At block 400, the synchronization service detects/receives a synchronization event for a source database and a target database and communicates a synchronization request to the source database and the target database. The synchronization event can be an event triggered by a synchronization schedule configured on the synchronization service or a manual input by a user to the synchronization service (e.g., at a software-as-a-service application interface). The synchronization event can indicate an identifier of the source and target databases and can further indicate any identifiers of records for a source and target dataset to be synchronized. The synchronization request to the source and target databases can indicate, when present, identifiers of records for the source dataset and target dataset, respectively. The synchronization request additionally indicates a choice and/or implementation configuration of a hash function and mapping function that will be shared by both the source and target databases. The synchronization requests to the source and target database indicate suspending the source and target database and/or respective datasets from further edits until synchronization is complete. The source and target database can buffer any updates to the source and target datasets until synchronization is complete.

At block 402, the source database generates a first set of coded symbols at the source database and communicates the first set of coded symbols to the synchronization service. The coded symbols are generated according to the aforementioned operations by randomly mapping source symbols to coded symbols, determining counts of mapped source symbols, and applying XOR and hashing operations to mapped source symbols. The source symbols can, depending on implementation, be the source dataset or representations of the source dataset that account for changes (i.e., inserts, deletes, updates) since last synchronization.

At block 406, the target database generates a second set of coded symbols and communicates the second set of coded symbols to the synchronization service. The target database generates the second set of coded symbols similarly to how the source database generates the first set of coded symbols, although the second set of coded symbols is generated for records of the target dataset and not representations of the target dataset.

At block 408, the synchronization service decodes differences between the first and second sets of coded symbols received from the source and target database. The decoding comprises subtracting the first and second sets of coded symbols and then iteratively peeling the resulting subtracted coded symbols. The operations at block 408 are described in greater detail in reference to FIG. 6. If the decoding fails, operations flow proceeds to block 410. Otherwise, if the decoding was successful, operational flow proceeds to block 412.

At block 410, the synchronization service requests an additional set of coded symbols from the source and target database. The source and target database each generate an additional set of coded symbols in response and communicate the additional sets of coded symbols to the synchronization service for further decoding. Operational flow returns to block 408. The operations at blocks 408 and 410 continue for iteratively attempting to decode coded symbols until there is a decode success. The use of the Rateless IBLT algorithm ensures that decoding success has a high probability of occurring with a reasonable number of coded symbols relative to the size of the source and target datasets.

At block 412, the synchronization service communicates an update of the target dataset to the target database to replicate the source dataset on the source database based on the decoded symbols. Each of the decoded symbols resulting from the decoded symbols comprises a source symbol that was present in the source dataset but not the target dataset or a source symbol that was present in the target dataset but not the source dataset. If there were no decoded symbols, i.e., there were no identified differences between the source and target dataset, no update is performed. The updates to the target dataset comprise deletions of source symbols present in the target dataset but not the source dataset and insertions of source symbols present in the source dataset but not the target dataset.

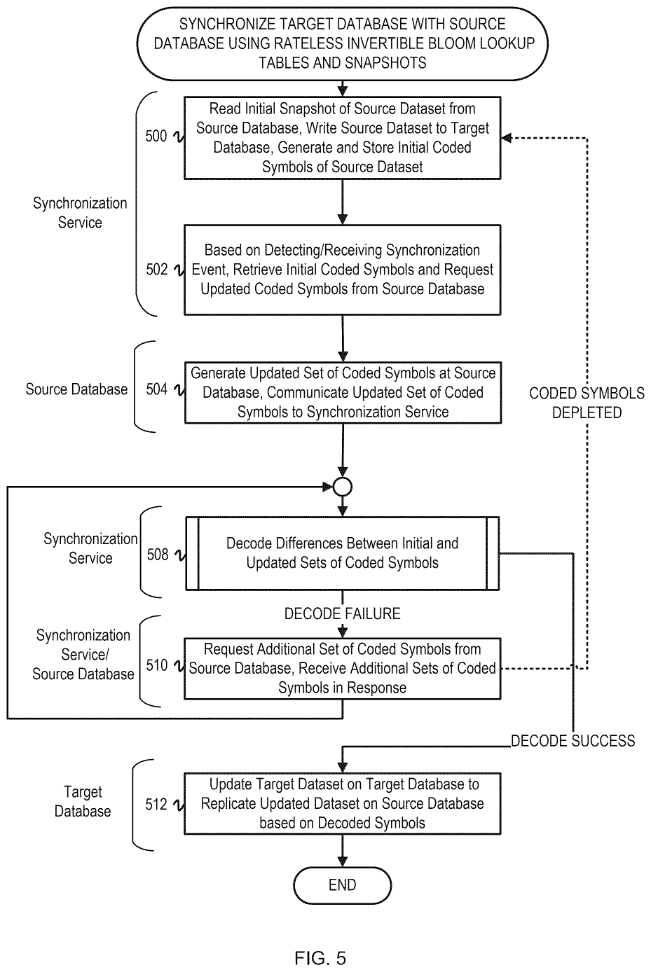

FIG. 5 is a flowchart of example operations for synchronizing a target database with a source database using Rateless IBLTs and snapshots. Many of the operations in FIG. 5 are described with brevity due to overlap with similar operations described in reference to FIG. 4.

At block 500, the synchronization service receives an initial snapshot of a source dataset from a source database, writes the source dataset to the target database, and generates and stores initial coded symbols of the source dataset. This example assumes that the source dataset has not previously been replicated at the target database, so doing set reconciliation with coded symbols would not yield any performance improvement. The initial coded symbols of the source dataset are generated from source symbols comprising records of the dataset as opposed to representations of the source dataset, because there are no changes to the source dataset to record.

At block 502, based on detecting/receiving a synchronization event subsequent to the initial snapshot, the synchronization service requests updated coded symbols from the source database.

At block 504, the source database generates an updated set of coded symbols and communicates the updated set of coded symbols to the synchronization service.

At block 508, the synchronization service decodes differences between the initial and updated sets of coded symbols, for instance as described in greater detail in reference to FIG. 6. If the decoding fails, operational flow continues to block 510. Otherwise, if the decoding is successful, operational flow proceeds to block 512.

At block 510, the synchronization service requests an additional set of coded symbols from the source database and receives an additional set of coded symbols in response. Operational flow returns to block 508. In some embodiments, decoding may not be possible due to insufficient stored coded symbols for the snapshot of the source dataset. If the synchronization service exhausts all coded symbols during the decoding attempts at blocks 508, 510 and decoding still fails, the synchronization service can either request additional coded symbols from the source database or can request an additional snapshot of the source dataset from the source database. The synchronization service then uses the additional coded symbols or coded symbols generated from the additional snapshot for decoding at blocks 508, 510 until success.

As indicated by the dashed arrow in FIG. 5, if a request for additional coded symbols from the source database results in a failure (i.e., the coded symbols at the source database have been depleted), then operational flow returns to block 500 to obtain an additional snapshot of the source dataset and generate additional coded symbols thereof. The number of coded symbols generated with the initial snapshot can be optimized across synchronizations based on numbers of coded symbols used at previous iterations. By contrast with prior approaches using (non-Rateless) IBLTs, where the size of the data structure generated for an initial snapshot can adversely impact sizes of subsequent data structures used for synchronizations (i.e., when the size of the snapshot becomes insufficient for synchronizations and a completely new snapshot needs to be generated), the number of coded symbols for the initial snapshot using Rateless IBLTs is independent of the size of sets of coded symbols required for any subsequent synchronizations. Moreover, the synchronization service can choose a large number of coded symbols for the initial snapshot to avoid having to perform additional snapshots, at the cost of increased storage of coded symbols in a synchronization database.

At block 512, the target database updates the target dataset to replicate the updated dataset on the source database based on the decoded symbols.

FIG. 6 is a flowchart of example operations for decoding differences between source coded symbols from a source database and target coded symbols from a target database. At block 600, the synchronization service subtracts the source coded symbols from the target coded symbols and appends the subtracted coded symbols to any existing coded symbols. As described in the foregoing, the subtraction operation for coded symbols comprises subtracting the count fields, bitwise XOR of the val_sum fields, and bitwise XOR of the hash_sum fields. The existing coded symbols comprise coded symbols from previous iterations of decoding where there was a decoding failure. For the first iteration, there is no appending operation.

At block 601, the synchronization service determines whether the count of the first coded symbol is 0. The count of the first coded symbol being 0 means that every source symbol has been decoded because every source symbol is mapped to the first coded symbol. The synchronization service additionally determines whether the hash field for the coded symbol also has value 0, meaning that any source symbols have been successfully decoded from the first coded symbol. The “first” coded symbol refers to the first coded symbol among both the subtracted coded symbols and any previous coded symbols to which the subtracted coded symbols were appended. If the first coded symbol has a count equal to 0 and a hash field with value 0, operational flow proceeds to block 610, the decoding is successful, and operational flow terminates. Otherwise, operational flow proceeds to block 602.

At block 602, the synchronization service determines whether there is a “pure” coded symbol. A coded symbol being “pure” means that the count field has a value of +1 or −1 and that the hash field of the coded symbol has a value equal to the hash of the value stored in a value field. If there is a pure coded symbol that satisfies both these criteria, operational flow continues to block 604. Otherwise, operational flow proceeds to block 608, the decoding fails, and operational flow terminates.

At block 604, the synchronization service decodes the source symbol from the pure coded symbol. As noted in the foregoing description, a coded symbol with count equal to plus 1 or −1 has the value of the source symbol in the val_sum field, so decoding comprises extracting this value. If the count is equal to +1, then the source symbol is present in the source dataset but not the target dataset. If the count is equal to −1, then the source symbol is present in the target dataset but not the source dataset. The synchronization service stores the decoded source symbol and an indication of set membership for a subsequent update to the target dataset when replicating the source dataset in the target database.

At block 606, the synchronization service removes the decoded source symbol from each coded symbol(s) to which it maps. The synchronization service determines which coded symbol(s) to which the decoded source symbol maps according to the mapping agreed upon between the synchronization service and the source and target databases prior to the operations described in reference to FIG. 6. The removal operation comprises, for each coded symbol to which the source symbol maps, subtracting the pure coded symbol from the mapped coded symbol. Operational flow returns to block 601.

### Variations

The foregoing description refers to updating a target dataset on a target database to replicate a source dataset on a source database. Substantially similar operations can be used for two-way dataset synchronization. The two-way dataset synchronization can also be performed using decoded symbols indicating differences between the source dataset and the target dataset, wherein the decoded symbols are generated according to the foregoing operations.

Databases according to the foregoing description can comprise any relational database managed with a RDBMS, for instance Structured Query Language (SQL) databases. More generally, the foregoing databases can comprise any databases that are able to implement the subroutine of the Rateless IBLT algorithm for generating coded symbols, for instance using a database management system or other database wrapper.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 402 and 406 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

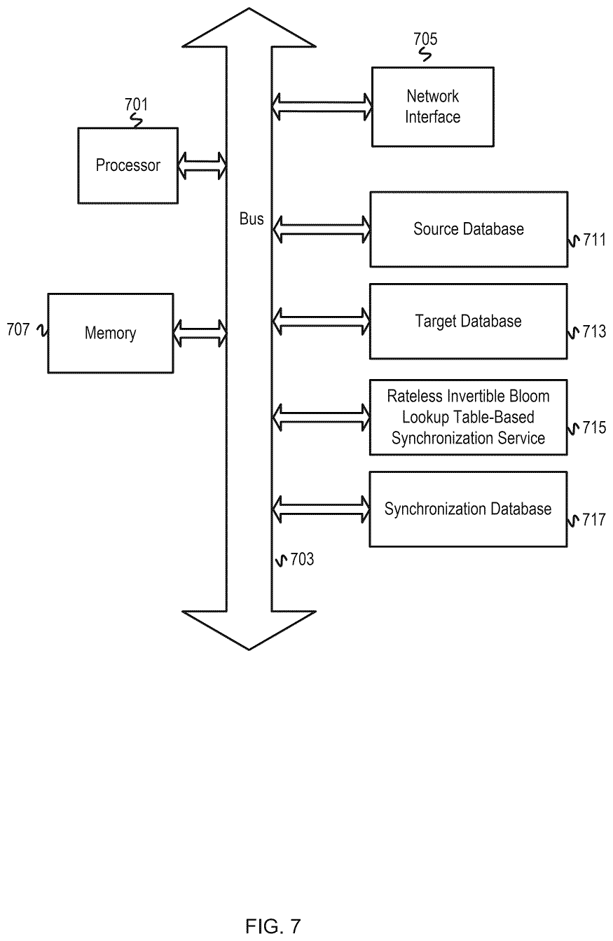

FIG. 7 depicts an example computer system with a source database, a target database, a Rateless IBLT-based synchronization service, and a synchronization database. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes a source database 711, a target database 713, a Rateless IBLT-based synchronization service (synchronization service) 715, and a synchronization database 717. The synchronization service 715 requests coded symbols of a source dataset on the source database 711 and a target dataset at the target database 715, wherein the coded symbols are generated at the database 711, 713 according to the Rateless IBLT algorithm described in the foregoing, implemented with a RDBMS. The synchronization service 715 then attempts to decode the coded symbols and, for a decoding failure, iteratively requests additional coded symbols from the database 713, 715 and attempts to decode using the additional coded symbols until decoding succeeds. The synchronization service 715 then performs synchronization of the source and target datasets using the decoded symbols. In some implementations, the synchronization service 715 takes snapshots of coded symbols for the source dataset and stores the snapshots in the synchronization database 717 to avoid having to request coded symbols from the target database 713 during synchronization. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
communicating a synchronization request to a source database and a target database, wherein the synchronization request comprises a request for synchronizing a source dataset at the source database with a target dataset at the target database;
based on receiving a first set of coded symbols and a second set of coded symbols from the source database and the target database, respectively, in response to the synchronization request, decoding the first set of coded symbols and the second set of coded symbols to obtain one or more decoded symbols, wherein the first set of coded symbols comprises encodings of a first plurality of source symbols for the source dataset and the second set of coded symbols comprises encodings of a second plurality of source symbols for the target dataset;
determining whether the source dataset and the target dataset are synchronized based on the indications of whether each of the one or more decoded symbols belongs to the first plurality of source symbols or the second plurality of source symbols; and
based on determining that the source dataset and the target dataset are not synchronized, updating the target dataset to be synchronized with the source dataset based, at least in part, on indications of the one or more decoded symbols that belong to the first plurality of source symbols or the second plurality of source symbols.

2. The method of claim 1, wherein decoding the first set of coded symbols and the second set of coded symbols comprises,
subtracting the first set of coded symbols and the second set of coded symbols to obtain a plurality of subtracted symbols; and
decoding the plurality of subtracted symbols to obtain the one or more decoded symbols and indications of whether each of the one or more decoded symbols belongs to the first plurality of source symbols or the second plurality of source symbols.

3. The method of claim 2, further comprising, based on determining that one or more of the plurality of subtracted symbols cannot be decoded:
iteratively communicating requests for additional symbols to the source database; and
decoding subsets of the additional symbols until the additional symbols can be decoded.

4. The method of claim 1, wherein at least the first plurality of source symbols comprises representations of at least one of inserts, deletes, and updates to the source dataset and the target dataset, respectively, since most recent synchronization.

5. The method of claim 4, wherein the representations of deletes comprise representations of primary key values in the source dataset, wherein updating the target dataset comprises,
determining that a decoded symbol in the one or more decoded symbols represents a primary key value in the first plurality of source symbols and that the primary key value is not in the second plurality of source symbols; and
communicating an indication to the target database to delete a record in the target dataset corresponding to the primary key value.

6. The method of claim 1, wherein each coded symbol of the first set of coded symbols and the second set of coded symbols comprises,
a count indicating a number of the first plurality of source symbols or a number of the second plurality of source symbols encoded by the coded symbol, and
a value and a hash representation of a subset of source symbols encoded by the coded symbol,
wherein generating the first set of coded symbols comprises choosing the subset of the plurality of source symbols according to a probability distribution for mapping each source symbol in the plurality of source symbols to a coded symbol in the plurality of coded symbols.

7. The method of claim 6, wherein the value of the subset of source symbols comprises a bitwise XOR of the subset of source symbols, wherein the hash representation comprises a bitwise XOR of hashes of the subset of source symbols.

8. The method of claim 7, wherein subtracting a first coded symbol in the first set of coded symbols and a second coded symbol in the second set of coded symbols to obtain a subtracted symbol in the plurality of subtracted symbols comprises,
computing a bitwise XOR of a first value in the first coded symbol and a second value in the second coded symbol to obtain a subtracted value;
computing a bitwise XOR of a first hash representation in the first coded symbol and a second hash representation in the second coded symbol to obtain a subtracted hash representation; and
computing a count indicating the count of the first coded symbol minus the count of the second coded symbol.

9. The method of claim 1, further comprising, based on receiving the synchronization request at the source database and receiving the synchronization request at the target database, generating, at the source database, the first set of coded symbols and generating, at the target database, the second set of coded symbols.

10. A non-transitory machine-readable medium having program code stored thereon, the program code comprising instructions to:
communicate a synchronization request to a source database and a target database, wherein the synchronization request comprises a request for synchronizing a source dataset at the source database with a target dataset at the target database;
based on receiving the synchronization request at the source database and receiving the synchronization request at the target database, generate, at the source database, the first set of coded symbols and generate, at the target database, the second set of coded symbols;
based on receiving a first set of coded symbols and a second set of coded symbols from the source database and the target database, respectively, decode the first set of coded symbols and the second set of coded symbols to obtain one or more decoded symbols, wherein the first set of coded symbols comprises encodings of a first plurality of source symbols for the source dataset and the second set of coded symbols comprises encodings of a second plurality of source symbols for the target dataset; and
determine whether the source dataset and the target dataset are synchronized based on the indications of whether each of the one or more decoded symbols belongs to the first plurality of source symbols or the second plurality of source symbols.

11. The machine-readable media of claim 10, wherein the program code further comprises instructions to, based on determining that the source dataset and the target dataset are not synchronized, update the target dataset to be synchronized with the source dataset based, at least in part, on indications of membership of the one or more decoded symbols in the first plurality of source symbols or the second plurality of source symbols

12. The machine-readable media of claim 10, wherein the instructions to decode the first set of coded symbols and the second set of coded symbols comprise instructions to:
subtract the first set of coded symbols and the second set of coded symbols to obtain a plurality of subtracted symbols; and
decode the plurality of subtracted symbols to obtain one or more decoded symbols and indications of whether each of the one or more decoded symbols belongs to the first plurality of source symbols or the second plurality of source symbols.

13. The machine-readable media of claim 12, wherein the program code further comprises instructions to, based on determining that one or more of the plurality of subtracted symbols cannot be decoded:
iteratively communicate requests for additional symbols to the source database; and
decode subsets of the additional symbols until the additional symbols can be decoded.

14. The machine-readable media of claim 10, wherein at least the first plurality of source symbols comprises representations of at least one of inserts, deletes, and updates to the source dataset and the target dataset, respectively, since most recent synchronization.

15. The machine-readable media of claim 14, wherein the representations of deletes comprise representations of primary key values in the source dataset, wherein the instructions to update the target dataset comprise instructions to:
determine that a decoded symbol in the one or more decoded symbols represents a primary key value in the first plurality of source symbols and that the primary key value is not in the second plurality of source symbols; and
communicate an indication to the target database to delete a record in the target dataset corresponding to the primary key value.

16. An apparatus comprising:
a processor; and
a machine-readable medium having instructions stored thereon that are executable by the processor to cause the apparatus to remotely synchronize datasets across databases with low communications overhead, wherein the instructions to remotely synchronize datasets across databases comprise instructions executable by the processor to cause the apparatus to,
communicate a synchronization request to a source database and a target database, wherein the synchronization request comprises a request for synchronizing a source dataset at the source database with a target dataset at the target database;
based on receiving a first set of coded symbols and a second set of coded symbols from the source database and the target database, respectively, in response to the synchronization request, decode the first set of coded symbols and the second set of coded symbols to obtain one or more decoded symbols, wherein the first set of coded symbols comprises encodings of a first plurality of source symbols for the source dataset and the second set of coded symbols comprises encodings of a second plurality of source symbols for the target dataset;
determine whether the source dataset and the target dataset are synchronized based on indications membership of each of the one or more decoded symbols belongs to the first plurality of source symbols or second plurality of source symbols; and
based on determining that the source dataset and the target dataset are not synchronized, update the target dataset to be synchronized with the source dataset based, at least in part, on the indications of membership of the one or more decoded symbols.

17. The apparatus of claim 16, wherein the instructions to decode the first set of coded symbols and the second set of coded symbols comprise instructions executable by the processor to cause the apparatus to:
subtract the first set of coded symbols and the second set of coded symbols to obtain a plurality of subtracted symbols; and
decode the plurality of subtracted symbols to obtain the one or more decoded symbols and indications of whether each of the one or more decoded symbols belongs to the first plurality of source symbols or the second plurality of source symbols.

18. The apparatus of claim 17, wherein the machine-readable medium further has stored thereon instructions executable by the processor to cause the apparatus to, based on determining that one or more of the plurality of subtracted symbols cannot be decoded:
iteratively communicate requests for additional symbols to the source database and the target database; and
decode subsets of the additional symbols until the additional symbols can be decoded.

19. The apparatus of claim 17, wherein at least the first plurality of source symbols comprises representations of at least one of inserts, deletes, and updates to the source dataset and the target dataset, respectively, since most recent synchronization.

20. The apparatus of claim 19, wherein the representations of deletes comprise representations of primary key values in the source dataset, wherein the instructions to update the target dataset comprise instructions executable by the processor to cause the apparatus to:
determine that a decoded symbol in the one or more decoded symbols represents a primary key value in the first plurality of source symbols and that the primary key value is not in the second plurality of source symbols; and
communicate an indication to the target database to delete a record in the target dataset corresponding to the primary key value.
